(19) United States
(12) Patent Application Publication
(10) Pub. No.: US 2026/0265021 A1
(43) Pub. Date: Sep. 10, 2026

(54) Powered Stairlift Seat Raiser for Enhanced Accessibility

(71) Applicant: Kevin G. Strafford-Price, Durham, NC (US)

(72) Inventor: Kevin G. Strafford-Price, Durham, NC (US)

(21) Appl. No.: 19/074,531

(22) Filed: Mar. 10, 2025

(51) Int. Cl. B66B 9/08

(52) U.S. Cl. CPC B66B 9/0853

(57) ABSTRACT

According to an aspect of the present invention, there is provided a stairlift apparatus comprising: a stairlift chair; a seat base for said stairlift chair, said seat base being pivotally mounted to said stairlift chair at a fulcrum point located at a forward-facing extent of said seat base; a powered lifting mechanism configured to raise and lower said seat base about said fulcrum point by exerting a force in a vertical direction while said stairlift apparatus is stationary; and a control system configured to activate and control said powered lifting mechanism and to prevent operation of said powered lifting mechanism while said stairlift apparatus is in motion, said control system configured to allow motion of said stairlift apparatus when said seat base is in a position suitable for safe transport.

### BACKGROUND

Adjustable seats for stairlifts have been disclosed in the prior art patent literature. Existing patents primarily focus on adapting the seat for space constraints or user restraint, rather than facilitating easy transfer For example, U.S. Pat. No. 9,758,348B2 discloses a stairlift with powered seat height adjustment, primarily for achieving a semi-perched position to navigate narrow staircases.

This patent also describes a seat design with a “pommel” intended to secure the user in place and prevent sliding forward, particularly in the perched position. The focus of this patent is on accommodating narrow stairs and ensuring user stability during transport, rather than facilitating easy transfer on and off the stairlift.

U.S. Pat. No. 11,690,456B2 describes a stairlift with a folding seat for compact storage when not in use.

EP1197465A1 presents a stairlift with a manually adjustable seat that can transform between a standard seat and a perched configuration for navigating various staircase layouts.

However, there remain limitations with each of the identified prior art documents and the challenge of assisting users with limited mobility during embarkation and disembarkation has continued to be a long-felt need in the art.

### SUMMARY OF INVENTION

Therefore, the present invention provides a stairlift in the form of a motorized chair that travels along a rail mounted to a staircase. It is designed to assist individuals with mobility challenges in safely navigating stairs. The user sits on the chair and is transported up or down the staircase by the motorized mechanism.

The seat may be reclined in the transport mode to enhance the user's sense of security.

Stairlifts are commonly used in homes, public buildings, and other locations where stairs may pose an obstacle for people with limited mobility.

This invention provides a powered stairlift seat base raiser that addresses the difficulties faced by individuals with limited mobility when getting on and off a stairlift. Unlike existing inventions that focus on space constraints or user restraint, this invention prioritizes ease of access to and from the seat.

The powered seat raising mechanism assists users in transitioning between the transport position and a more upright position suitable for embarkation and disembarkation.

Regardless of the seat's recline angle, the powered seat raising mechanism assists users in transitioning between the transport position and a more upright position suitable for embarkation and disembarkation.

### BRIEF DESCRIPTION OF THE DRAWINGS

FIG. 1 depicts a perspective view of the stairlift, showcasing the seat in the raised position for embarking and disembarking.

FIG. 2 illustrates front and side elevation view of the stairlift seat base in the raised position.

FIG. 3 illustrates a perspective view of the stairlift seat base in the transport position.

FIG. 4 illustrates a close-up view of the seat base in the elevated position.

FIG. 5 illustrates provides a schematic diagram of the control system for the powered stairlift option.

### DETAILED DESCRIPTION

The stairlift seat raiser of the present invention comprises a seat base designed to support loads up to 400 lbs without significant deformation. The seat base can be constructed from various materials with sufficient strength, such as reinforced polymers, metal alloys, composites, wood, or wood laminates.

For enhanced user comfort, the seat base can be optionally covered with a softer material, such as foam padding or upholstery.

The seat base is pivotally mounted to the stairlift chair frame at a fulcrum point located at the forward-facing extent of the seat base. This fulcrum point comprises a hinge, which is ideally, but not necessarily, firmly affixed to the main seat frame. This arrangement ensures robust support for the applied loads in both the transport position and the raised embarking/disembarking position.

While the seat raising and lowering mechanism could be manually operated, the preferred embodiment utilizes a powered lifting mechanism.

This mechanism is located at the rear (back) of the seat base and is designed to generate linear or rotary motion under electrical power. The generated motion applies a force sufficient to lift or lower the seat base between the desired positions.

The powered lifting mechanism is connected to an operational switching device that controls its activation. This switching device is designed to allow operation of the seat base motion only when the stairlift is in the parked position at the top or bottom of the stairs.

To prevent accidental operation during stairlift motion, the electrical lifting circuits can be interconnected with sensors that detect the stairlift's movement status. These sensors can forgo the option of seat base lifting or lowering while the stairlift is in motion.

The seat base can be configured to raise through an angle of up to 95 degrees, providing ample clearance for users to get in and out of the seat.

The specific range of the lift can be adjusted based on the intended application and user needs.

The lifting action is controlled by a constant force signal, which can be either hard-wired or transmitted wirelessly. When the signal is removed, the lifting or lowering operation stops.

This allows for precise control of the seat base position.

The powered stairlift seat raiser of the present invention can be used in various settings, including both indoor and outdoor environments.

The design is not limited to staircases and can be adapted for use on other fixed medians where a powered lifting seat on an inclined chair lift would be beneficial.

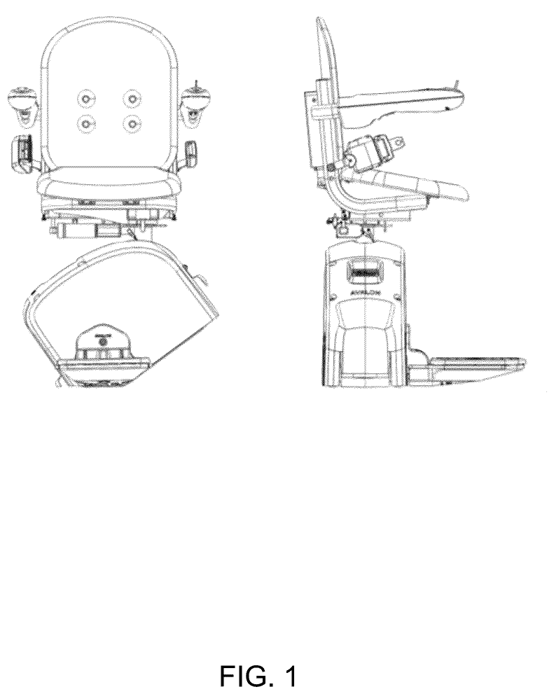

FIG. 1 depicts a perspective view of the stairlift, showcasing the seat in the raised position for embarking and disembarking.

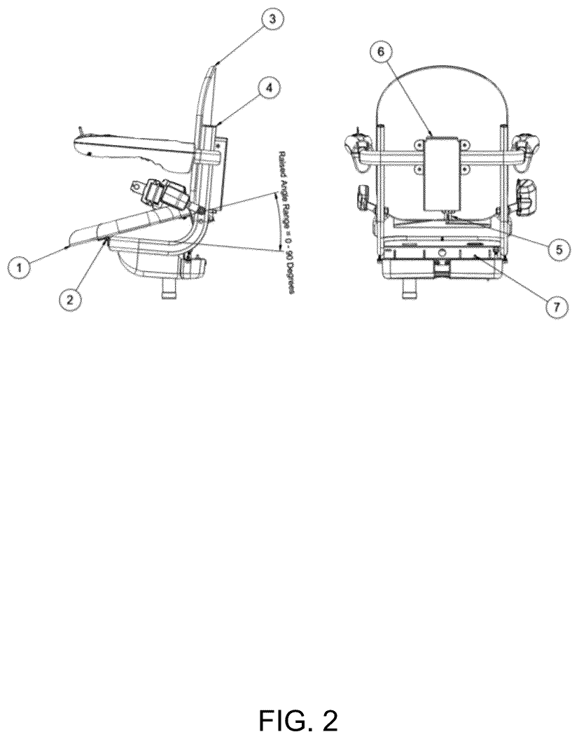

FIG. 2 illustrates front and side elevation view of the stairlift seat base in the raised position.

This figure includes numbered balloons identifying the following components:
1. Seat Base 2. Seat Pivot (Fulcrum Hinge) 3. Seat Back 4. Seat Frame 5. Lifting Force Source (Linear Actuator) 6. Seat Frame Supporting Structure 7. Position Switch (Optional).

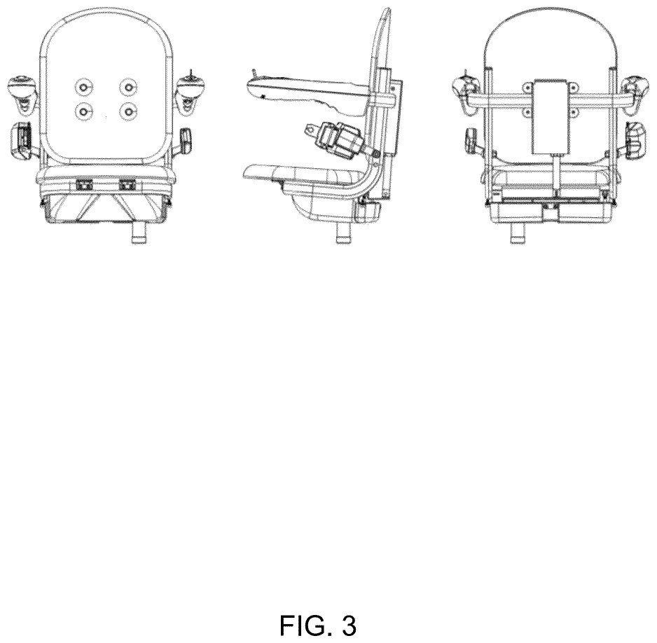

FIG. 3 illustrates a perspective view of the stairlift seat base in the transport position.

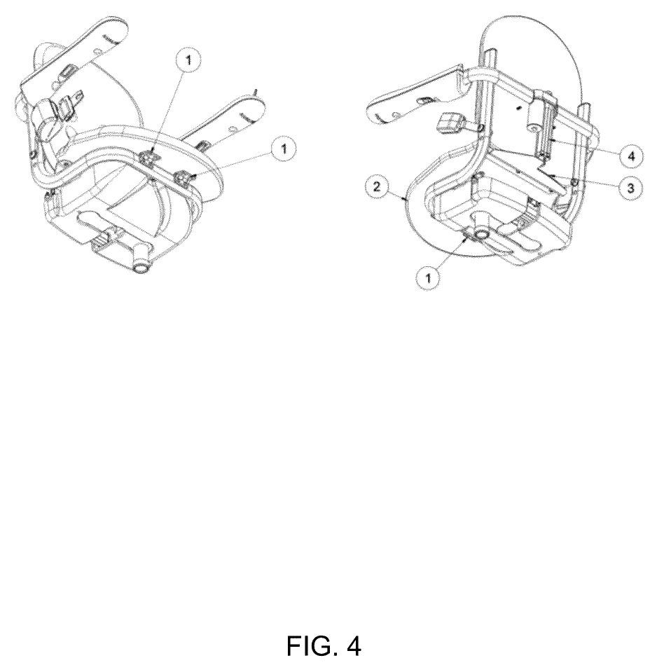

FIG. 4 illustrates a close-up view of the seat base in the elevated position.

This view highlights the pivotal mounting of the seat base at the fulcrum point (Hinge, item 1) and the connection of the seat base (item 2) to the powered lifting mechanism (item 4) via the seat base lifting bracket (item 3). The bracket is firmly secured to both the seat base and the lifting mechanism, using either a flexible or fixed connection.

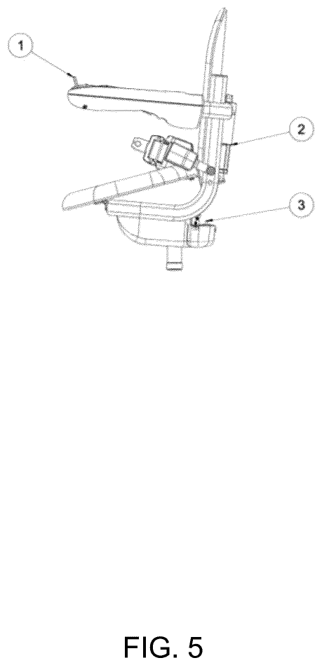

FIG. 5 illustrates provides a schematic diagram of the control system for the powered stairlift option.

It depicts the user control (item 1), optional interface safety and feedback sensors (item 3), and the connections to the powered lifting mechanism (item 2).

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A stairlift apparatus comprising:
a stairlift chair;
a seat base for said stairlift chair, said seat base being pivotally mounted to said stairlift chair at a fulcrum point located at a forward-facing extent of said seat base;
a powered lifting mechanism configured to raise and lower said seat base about said fulcrum point by exerting a force in a vertical direction while said stairlift apparatus is stationary; and
a control system configured to activate and control said powered lifting mechanism and to prevent operation of said powered lifting mechanism while said stairlift apparatus is in motion, said control system configured to allow motion of said stairlift apparatus when said seat base is in a position suitable for safe transport, said control system configured to regulate ascent speed and limit rise height,
wherein the powered lifting mechanism is housed within the stairlift chassis and mechanically coupled directly to the seat base.

2. The stairlift apparatus of claim 1, wherein said control system is configured to allow a user to selectively activate or deactivate said powered lifting mechanism.

3. The stairlift apparatus of claim 1, wherein said control system includes a control device configured to stop said powered lifting mechanism at a desired position.

4. The stairlift apparatus of claim 3, wherein said control device is remotely mounted.

5. The stairlift apparatus of claim 3, wherein said control device is integrated into said stairlift.

6. The stairlift apparatus of claim 1, wherein said powered lifting mechanism comprises at least one of a pneumatic, hydraulic, or electric mechanism.

7. The stairlift apparatus of claim 1, further comprising a lifting bracket secured to both the seat base and the lifting mechanism.

8. The stairlift apparatus of claim 7, wherein the lifting bracket is secured by a flexible connection.

9. The stairlift apparatus of claim 7, wherein the lifting bracket is secured by a firm connection.

10. The stairlift apparatus of claim 3, wherein said control device is controlled by a constant force signal.

11. The stairlift apparatus of claim 10, wherein the constant force signal is hard-wired.

12. The stairlift apparatus of claim 10, wherein the constant force signal is transmitted wirelessly.

13. The stairlift apparatus of claim 10, wherein electrical lifting circuits are interconnected with sensors that detect the stairlift's movement status.

14. The stairlift apparatus of claim 13, wherein the sensors can prevent use of the option of seat base lifting or lowering while the stairlift is in motion.

15. The stairlift apparatus of claim 1, wherein the seat base can be configured to raise through an angle of up to 95 degrees.

16. The stairlift apparatus of claim 1, wherein the powered lifting mechanism is configured to raise the seat along a guided, upward-and-forward path with synchronized rise-and-tilt motion generated by a single actuator or coordinated linkage.

17. The stairlift apparatus of claim 1, wherein the seat-assist function is configured to reduce user effort during standing transition”

18. The stairlift apparatus of claim 1, wherein a dual-axis support linkage constrains the seat to a defined rise trajectory.
